(19) United States
(12) Patent Application Publication
(10) Pub. No.: US 2005/0190289 A1
(43) Pub. Date: Sep. 1, 2005

(54) Image photographing apparatus and a method for assembling the same

(75) Inventor: Ji-seok Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/058,280

(22) Filed: Feb. 16, 2005

(30) Foreign Application Priority Data
Feb. 28, 2004 (KR) 2004-13802

(51) Int. Cl. H04N 5/225

(52) U.S. Cl. 348/373

(57) ABSTRACT

An image photographing apparatus includes a deck assembly having a deck unit, a main board and a camera unit that are connected with each other. A first exterior assembly has a first exterior frame housing on one side of the deck assembly, and a door exposing the deck unit. A second exterior assembly has a display unit and a second exterior frame connected with the display unit. The second exterior assembly housing is positioned on the other side of the deck assembly. A front unit covers the front side of the deck assembly. A rear unit covers the rear side of the deck assembly.

### CROSS-REFERENCE TO RELATED APPLICATIONS

This application claims the benefit under 35 U.S.C. § 119(a) of Korean Patent Application No. 2004-13802 filed Feb. 28, 2004 in the Korean Intellectual Property Office, the entire disclosure of which is hereby incorporated by reference.

### BACKGROUND OF THE INVENTION

1. Field of the Invention

The present invention relates to an image photographing apparatus that is capable of photographing an image, storing and reproducing the photographed image, and a method for assembling the same.

2. Description of the Related Art

Generally, a magnetic recording and reproducing apparatus, such as a camcorder, is widely used to record and reproduce an image and a sound of a subject to and from a recording media, such as a tape.

The camcorder typically includes an exterior case forming the external appearance, a lens unit for photographing a subject, a deck unit for recording and reproducing the photographed image, and a display unit.

The exterior case includes a plurality of frames. Generally, the above units are assembled in the case, and then each frame is finally assembled.

The lens unit and deck unit are electrically connected to each other in the exterior case. For this, a plurality of circuit boards including a main board and a sub board are configured in the exterior case. The main board is electrically connected with the sub board and boards for controlling each unit.

The deck unit operates to record and reproduce information on a recording media, such as a cassette tape. The display unit includes a LCD panel for independently displaying the photographed or reproduced image, respectively, and a viewfinder. The LCD panel and the viewfinder are configured at the outer side of the exterior case to be exposed, and are mounted on the main board to be electrically connected.

As described above, an image photographing apparatus consists of parts having various complicated structure, and therefore, the assembling process is complicated and difficult. Accordingly, it is more expensive to produce and assemble the image photographing apparatus, and the improvement of productivity is limited.

In view of the above drawbacks, the simplification of basic units for the image photographing apparatus and of assembling process of the basic units have been continuously investigated.

Accordingly, a need exists for image photographing apparatus that is easily assembled and a method for easily assembling the image photographing apparatus.

### SUMMARY OF THE INVENTION

The present invention has been conceived to solve the above-mentioned problems occurring in the prior art, and an aspect of the present invention is to provide an advanced image photographing apparatus having improved assembability and the method for assembling the same.

An image photographing apparatus includes a deck assembly having a deck unit, a main board and a camera unit, each being connected with each other. The first exterior assembly has the first exterior frame housing on one side of the deck assembly, and a door exposing the deck unit. The second exterior assembly has the display unit and the second exterior frame connected with the display unit. The second exterior assembly housing is on the other side of the deck assembly. A front unit covers the front side of the deck assembly. A rear unit covers the rear side of the deck assembly.

The main board is connected with the deck unit. The camera unit is supported by the main board. The camera unit and the deck unit may each be electrically connected with the main board.

The display unit may include an LCD panel movably connected at the outer side of the second exterior frame. A viewfinder unit may be connected inside of the second exterior frame and aligned with the camera unit in a substantially symmetrical manner.

The second exterior assembly may be supported by the inside of the second exterior frame, and have a sub board electrically connected with the display unit.

The sub board may be electrically connected with the main board.

The viewfinder unit may include a viewfinder cover connected with the second exterior frame. A viewfinder may be supported by the viewfinder cover and connected with the second exterior frame.

The front unit may include a front board electrically connected with the main board, and a front frame connected with the front board, the first and second exterior frame.

With the deck assembly assembled to the first exterior assembly, the front unit may be assembled to the first exterior assembly and the deck assembly.

The front board may be directly and electrically assembled to the main board.

The rear unit may include a rear frame having an opening to expose the camera unit; and a microphone supported by the rear frame. The first and second exterior assemblies may be connected, and then the exterior assemblies may be simultaneously connected.

A method of assembling an image photographing apparatus including a deck assembly having a deck unit, a main board and a camera unit in which each are connected with each other. The first exterior assembly has the first exterior frame housing on one side of the deck assembly and a door exposing the deck unit. The second exterior assembly has the display unit and the second exterior frame connected with the display unit. The second exterior assembly houses the other side of the deck assembly. A front unit covers the front side of the deck assembly. A rear unit covers the rear side of the deck assembly. The method includes the steps of preparing the deck assembly, the first and second exterior assembly, the front unit and the rear unit by each module unit. Assembling the front unit to the second exterior assembly to cover the front portion. Assembling the first exterior assembly to the first exterior assembly and the front unit to cover the deck assembly. Assembling the rear unit to the first and second exterior assembly to cover the rear portion.

The first exterior assembly may further include a sub board electrically connected with the display unit. The method may further include the step of electrically connecting the sub board and the main board before assembling the first exterior assembly to the second exterior assembly.

The main board and the sub board may be connected by a signal cable.

The front unit may include a front board connected with the main board. A front frame supports the front board. The step of assembling the front unit may include the steps of assembling the front frame supporting the front board to the second exterior frame, and then connecting the front board to the main board.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other aspects, features and advantages of the present invention will be more apparent from the following detailed description taken with reference to the accompanying drawings, in which:

FIG. 1 is an exploded perspective view of an image photographing apparatus according to an embodiment of the present invention;

FIG. 2 is an exploded perspective view of the deck assembly shown in FIG. 1;

FIG. 3 is an exploded perspective view of the first exterior assembly shown in FIG. 1;

FIG. 4 is an exploded perspective view of the second exterior assembly shown in FIG. 1;

FIG. 5 is an exploded perspective view of the front unit shown in FIG. 1;

FIG. 6 is a rear perspective view of the front unit shown in FIG. 5;

FIG. 7 is a perspective view of the deck assembly assembled with the first exterior assembly shown in FIG. 1;

FIG. 8 is a perspective view of the deck assembly of FIG. 7 further assembled with the front unit;

FIG. 9 is a perspective view of the deck assembly of FIG. 8 further assembled with the second exterior assembly; and

FIG. 10 is a perspective view of an assembled image photographing apparatus according to an embodiment of the present invention.

Throughout the drawings, like reference numerals will be understood to refer to like parts, components and structures.

### DETAILED DESCRIPTION OF EXEMPLARY EMBODIMENTS

Certain embodiments of the present invention will be described in greater detail with reference to the accompanying drawings. The matters defined in the description, such as a detailed construction and elements thereof, are provided to assist in a comprehensive understanding of the invention. Thus, it is apparent that the present invention may be carried out without those defined matters. Also, well-known functions or constructions are not described in detail since they may obscure the invention in unnecessary detail.

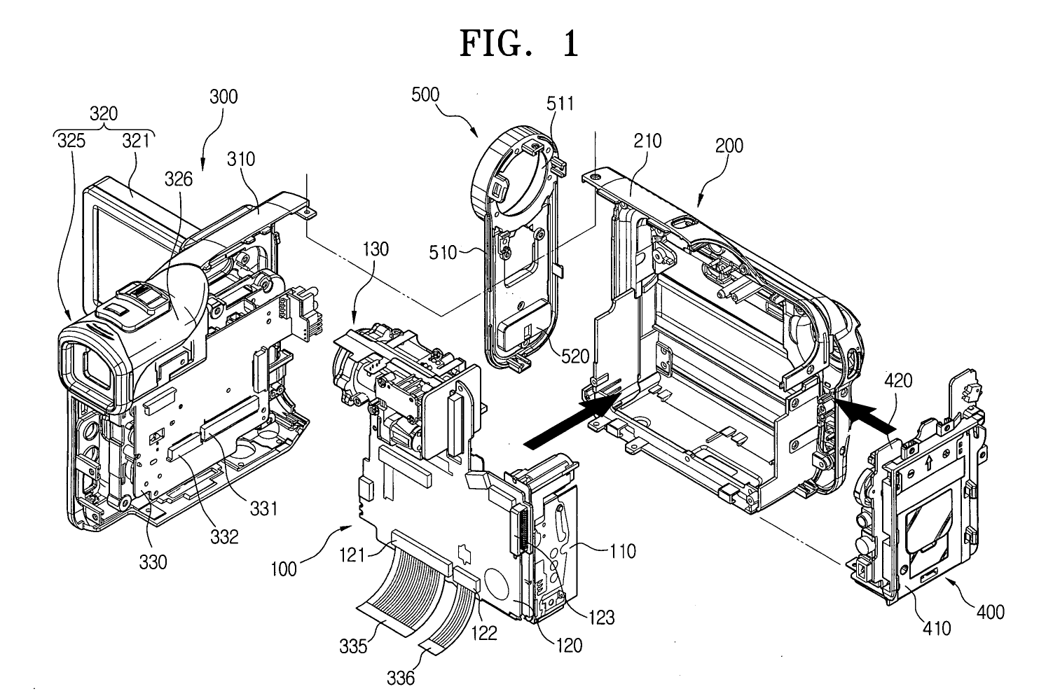

Referring to FIG. 1, an image photographing apparatus according to an embodiment of the present invention includes a deck assembly 100, a first exterior assembly 200, a second exterior assembly 300, a front unit 400 and a rear unit 500.

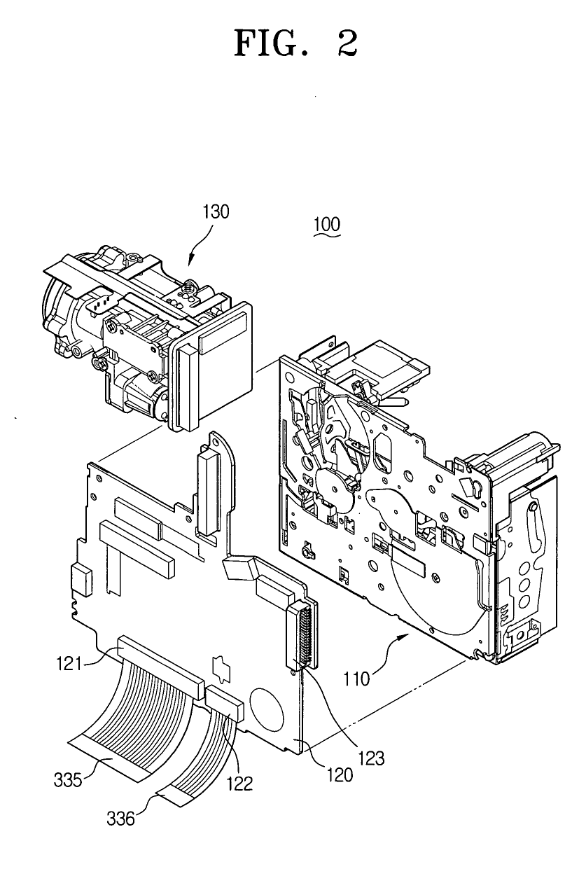

Referring to FIG. 2, the deck assembly 100 includes a deck unit 110, a main board 120 and a camera unit 130. The deck unit 110 records data including an image to a magnetic tape and reproduces the recorded data. The deck unit 110 is well-known, including such features as a general ‘moving deck’, and therefore, the detailed description thereof is omitted. The main board 120 is connected with the base side of the deck unit 110. The main board 120 is electrically connected with the deck unit 110 to transmit signals. The main board supports the camera unit 130. The camera unit 130 is located on the upper part of the main board 120 to incline to one side, with the deck unit 110 and the main board 120 being positioned to stand substantially upright.

The camera unit 130 is electrically connected with the main board 120 to transmit signals. The main board 120 is connected with the deck unit 110 and the camera unit 130 through circuit cables. The camera unit 130 captures an image, and the technique thereof is well-known so that the detailed description thereof is omitted.

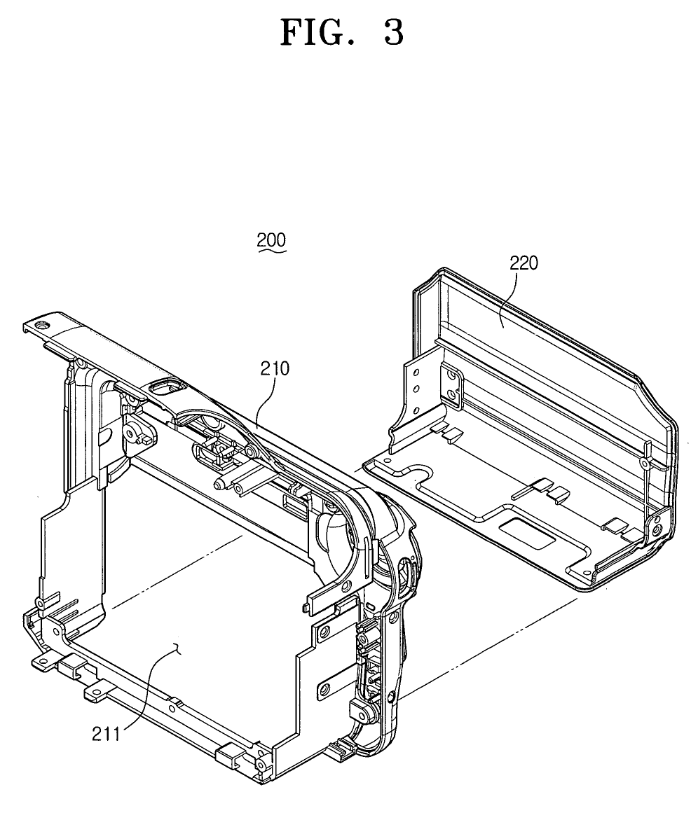

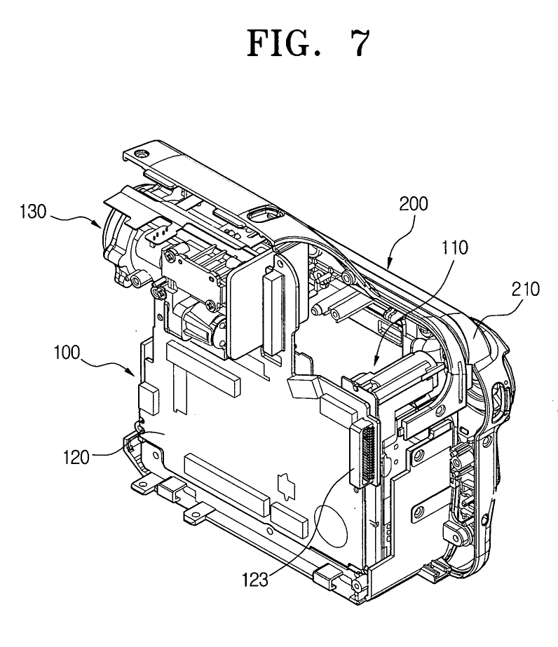

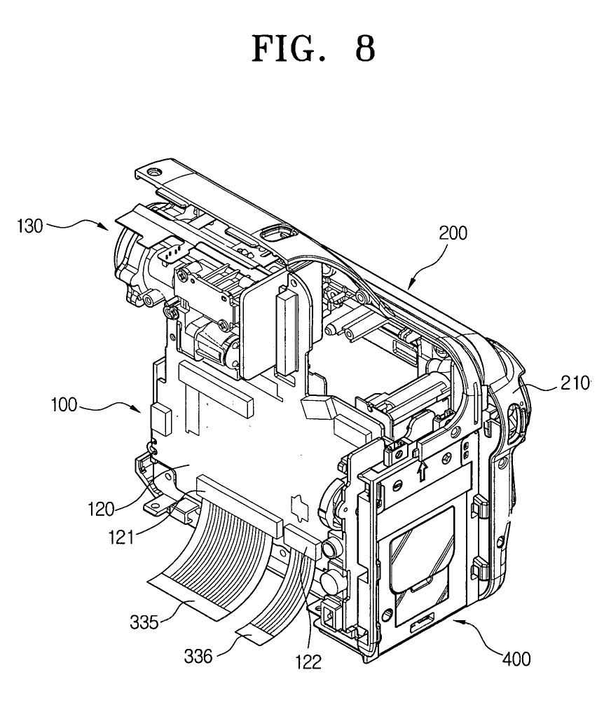

Referring to FIG. 3, the first exterior assembly 200 includes the first exterior frame 210 housing one side of the deck assembly 100. A door 220 is hingedly connected at the first exterior frame 210. The first exterior frame 210 is shaped to enclose and cover the deck unit 110 and the camera unit 130, and has an opening 211 adjoining with the door 220. The deck unit 110 is exposed through the opening 211. That is, the door 220 is connected with the first exterior frame 210 to open and close the opening 211. To mount a tape cassette as a recording media to the deck unit 110, the door 220 is opened. The deck assembly 100 is fitted in the first exterior assembly 200 for a sub-assembled condition, as shown in FIG. 7.

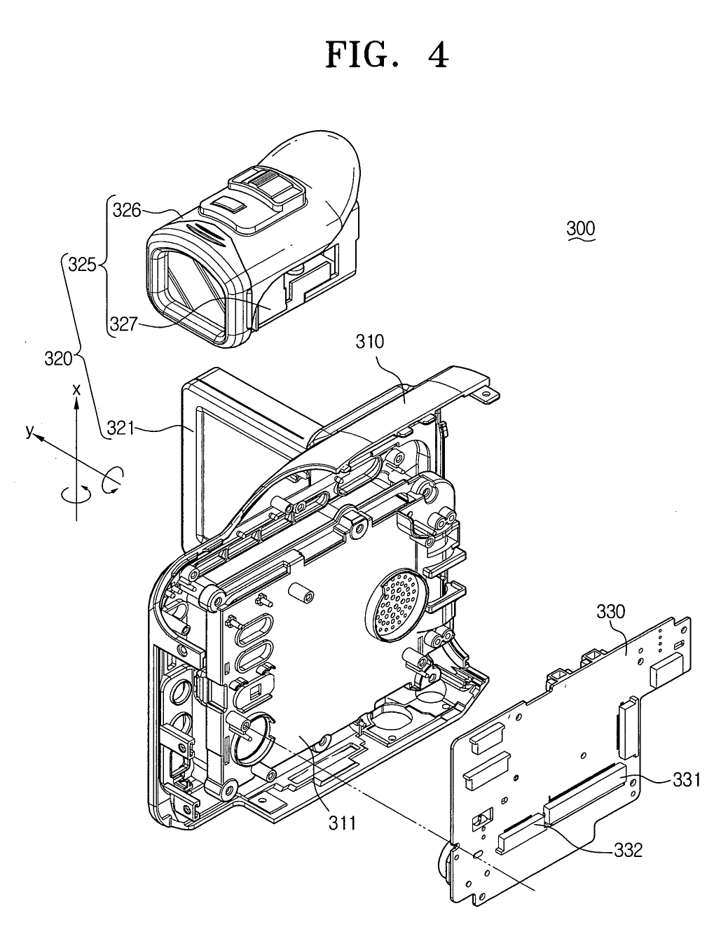

Referring to FIG. 4, the second exterior assembly 300 includes the second exterior frame 310, a display unit 320 connected with the second exterior frame 310, and a sub board 330. The second exterior frame 310 is a counterpart of the first exterior frame, and covers the other side of the deck assembly 100. A panel mounting part 311 is recessed at the second exterior frame 310, for receiving the LCD panel 321 which is described below.

The display unit 320 includes an LCD panel 321 movably connected at the second exterior frame 310, and a viewfinder unit 325 engaged in the exterior frame 310. The LCD panel 321 is pivotable with respect to the second exterior frame 310 by certain angles with respect to the two axes, x and y, which are perpendicular to each other. The LCD panel 321 is housed in the panel mount part 311.

The viewfinder unit 325 includes a viewfinder cover 326 engaged in the upper part of the second exterior frame 310, and a viewfinder 327 engaged with the viewfinder cover 326. The viewfinder 327 displays an image That is photographed or reproduced by the camera unit 130, and the detailed description thereof is omitted because the technique is well-known.

The sub board 330 is engaged in the second exterior frame 310. The sub board 330 is electrically connected with the LCD panel 321 and the viewfinder 327 to transmit signals. The sub board 330 includes a plurality of connectors 331 and 332. The connectors 331 and 332 are electrically connected with the connectors 121 and 122 on the main board 120 via the signal cables 335 and 336 to cover the deck assembly 100, before assembling the second exterior assembly 300 to the first exterior assembly 200.

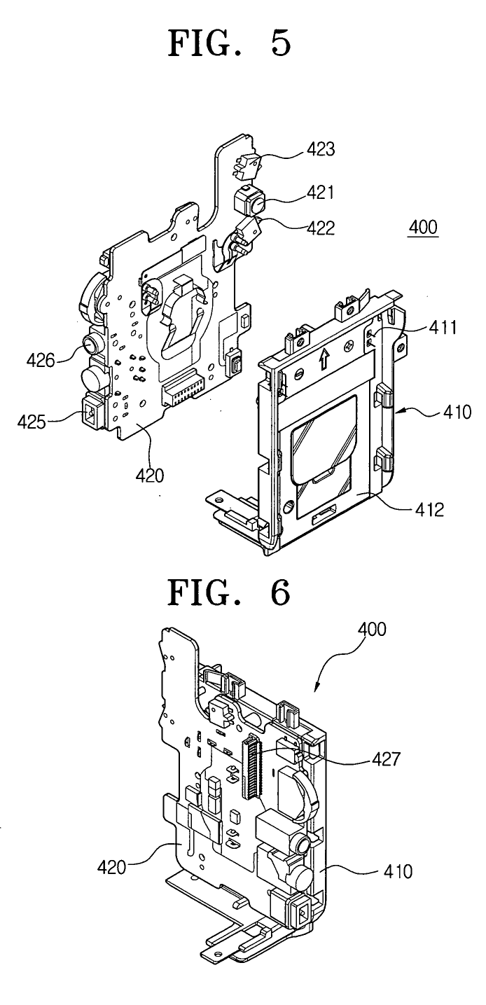

Referring to FIGS. 5 and 6, the front unit 400 includes a front frame 410, and a front board 420 engaged in the front frame 410. The front frame 410 covers the front part of the apparatus, that is, the deck assembly 100 in the direction of the viewfinder unit 325. The battery mount groove 412 has a terminal 411 connected at the front side of the front frame 410 to mount the battery. The front frame 410 is assembled to the first and second exterior frames 210 and 310. The front board 420 includes switches 421, 422 and 423 corresponding to a plurality of input buttons for inputting input signals from the outside. Ports 425 and 426 are for inputting and outputting various signals. The front board 420 includes a connector 427 that is directly and electrically connected with the connector 123 (refer to FIG. 2) of the main board 120, as shown in FIG. 6. The front board 420 is supported directly by connecting with the main board 120 without a separate signal cable.

Referring to FIG. 1, the rear unit 500 covers the rear side of the apparatus, that is, the camera unit 130. The rear unit 500 includes a rear frame 510 assembled to the first and second exterior frames 210 and 310. A microphone 520 is connected to the rear frame 510. The rear frame 510 includes an opening 511 for exposing the lens of the camera unit at the upper side. A plurality of holes (not shown) are configured at the front side of the lower part of rear frame 510 to easily obtain audio signal. The microphone 520 is supported on the portion corresponding to the holes, and the microphone 520 is electrically connected with the main board 120 via a cable (not shown).

As described above, an image photographing apparatus of the present invention is assembled mainly by five modular units, as shown in FIG. 1. Each assembly and unit is assembled through each assembly process. Five assemblies and units are assembled and produced to finished products through the assembly process described below.

First, assemblies 100, 200, 300, 400 and 500 are assembled and prepared as five modular units, as shown in FIG. 1.

The deck assembly 100 is first assembled to the first exterior assembly 200. As shown in FIG. 7, the deck assembly 100 is housed in the first exterior assembly 200, enclosing one side of the deck assembly. The deck unit 110 is connected adjacent the first exterior frame 210, and the deck unit 110 may be accessed through the door 220 connected to the first exterior frame 210.

A sub-assembly of the front unit 400 is assembled to the first exterior frame 210, as shown in FIG. 8. The connector 421 of the front panel 420 is connected with the connector 123 of the main board 120.

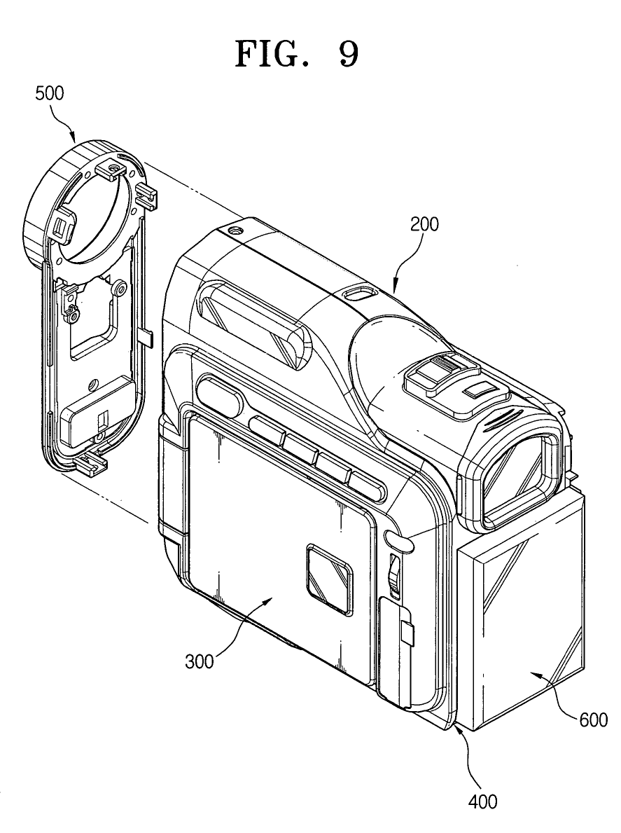

Prior to assembling the second exterior assembly 300 to the first exterior assembly 100, the signal cables 335 and 336 are connected to the sub board 330 of the second exterior assembly 300 and are electrically connected with the connectors 121 and 122 of the main board 120, thereby electrically connecting the sub board 330 and the main board 120. As described above, the boards 120 and 320 are electrically connected, and then the second exterior assembly 300 is assembled opposite to the first exterior assembly 100, as shown in FIG. 9.

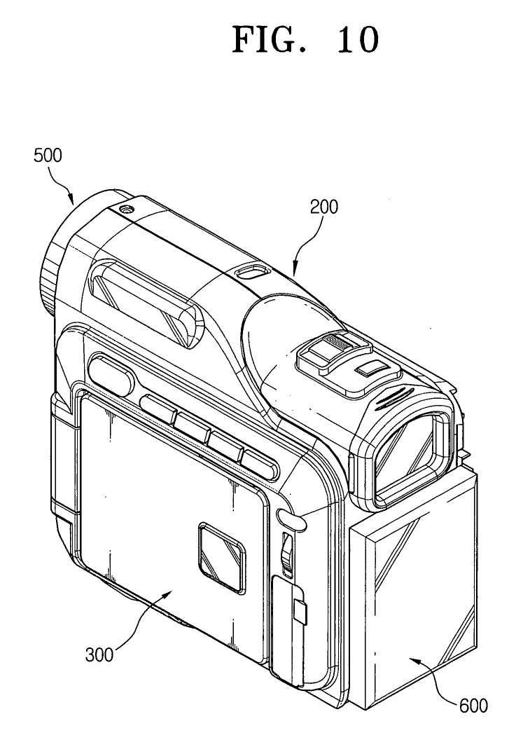

When the rear unit 500 is assembled to the frames 210 and 310 at the rear portion of the frames 210 and 310 to cover the camera unit 130 as shown in FIG. 9, the image photographing apparatus is assembled to a condition as shown in FIG. 10. The microphone 520 is connected with the main board 120. When four assemblies and units 200, 300, 400 and 500 are assembled with respect to the deck assembly 100, the assembled assemblies and units 100, 200, 300, 400 and 500 are fastened by a plurality of screws (not shown), and all the assembly processes are finished. FIGS. 9 and 10 views of an image photographing apparatus having a battery 600 on the front unit 400.

As described above, if an image photographing apparatus and the method for assembling the same according to an embodiment of the present invention are applied, each part is divided by pre-assembled modular units and then each modular unit is assembled one by one. Therefore, the assembly process becomes simplified.

Since each modular unit is assembled in the predetermined order in view of electrical connection among the main board and various parts, misassembling may be prevented and assemblability may be increased.

Because the image photographing apparatus is divided by five modular units, the apparatus may be easily repaired and parts may be easily replaced as necessary.

Additional advantages, objects, and features of the embodiments of the invention will be set forth in part in the description that follows and in part will become apparent to those having ordinary skill in the art upon examination of the description, or may be learned from practice of the invention. The objects and advantages of the embodiments of the invention may be realized and attained as particularly pointed out in the appended claims.

1. An image photographing apparatus, comprising:
a deck assembly having a deck unit, a main board and a camera unit, each being connected with each other;
a first exterior assembly having a first exterior frame housing on one side of the deck assembly, and a door adapted to expose the deck unit;
a second exterior assembly having a display unit and a second exterior frame connected with the display unit, the second exterior assembly housing being positioned on another side of the deck assembly;
a front unit covering the front side of the deck assembly; and
a rear unit covering the rear side of the deck assembly.

2. The image photographing apparatus according to claim 1, wherein
the main board is connected with the deck unit, the camera unit is supported by the main board, and the camera unit and the deck unit are each electrically connected with the main board.

3. The image photographing apparatus according to claim 1, wherein
the display unit comprises an LCD panel movably connected to an outer side of the second exterior frame; and
a viewfinder unit connected inside of the second exterior frame and aligned with the camera unit in a substantially symmetrical manner.

4. The image photographing apparatus according to claim 1, wherein
the second exterior assembly is supported by the second exterior frame, and includes a sub board electrically connected to the display unit.

5. The image photographing apparatus according to claim 4, wherein
the sub board is electrically connected to the main board.

6. The image photographing apparatus according to claim 3, wherein
the viewfinder unit includes a viewfinder cover connected with the second exterior frame; and
a viewfinder supported by the viewfinder cover and connected with the second exterior frame.

7. The image photographing apparatus according to claim 1, wherein
the front unit includes a front board electrically connected to the main board; and
a front frame connected with the front board, and the first and second exterior frames.

8. The image photographing apparatus according to claim 7, wherein
the front unit is assembled to the first exterior assembly and the deck assembly when the deck assembly has been connected to the first exterior assembly.

9. The image photographing apparatus according to claim 7, wherein
the front board is be directly and electrically connected to the main board.

10. The image photographing apparatus according to claim 1, wherein
the rear unit includes a rear frame having an opening to expose the camera unit; and
a microphone supported by the rear frame,
the rear unit being connected to both the first and second exterior assemblies after the first and second exterior assemblies are connected.

11. A method of assembling an image photographing apparatus, comprising the steps of:
preparing a deck assembly, first and second exterior assemblies, a front unit and a rear unit of the image photographing apparatus
connecting a deck unit, a main board and a camera unit of the deck assembly to each other;
connecting the first exterior assembly having a first exterior frame housing and a door adapted to expose the deck unit to the deck assembly, the first exterior assembly covering a first side of the deck assembly;
connecting the second exterior assembly having a display unit and a second exterior frame connected with the display unit to the first exterior assembly and to the deck assembly, the second exterior assembly covering a second side of the deck assembly;
connecting the front unit to the assembled deck assembly and first and second exterior assemblies to cover a front side of the deck assembly; and
connecting the rear unit to the assembled deck assembly, first and second exterior assemblies and front unit to cover a rear side of the deck assembly.

12. The method of claim 11, further comprising
electrically connecting a sub board with the display unit; and
electrically connecting the sub board and the main board prior to assembling the first exterior assembly to the second exterior assembly.

13. The method of claim 12, further comprising
connecting the main board and the sub board by a signal cable.

14. The method of claim 1, further comprising
supporting a front board with a front frame;
connecting the front frame supporting the front board to the second exterior frame; and
connecting the front board to the main board.

15. The method of claim 11, further comprising
connecting a battery to the front unit.

16. The method of claim 11, further comprising
supporting a microphone on the rear unit; and
connecting the microphone to the main board.
